(19) United States
(12) Patent Application Publication
(10) Pub. No.: US 2023/0345878 A1
(43) Pub. Date: Nov. 2, 2023

(54) AGRICULTURAL MACHINES AND METHODS FOR CONTROLLING WINDROW PROPERTIES

(71) Applicant: AGCO Corporation, Duluth, GA (US)

(72) Inventors: Kevin J. Hamilton, Newton, KS (US); Friedrich Robert Honeyman, Hesston, KS (US)

(21) Appl. No.: 17/930,633

(22) PCT Filed: Apr. 7, 2021
(86) PCT No.: PCT/IB2021/052879

§ 371 Date: Sep. 8, 2022

Related U.S. Application Data
(60) Provisional application No. 63/015,183, filed on Apr. 24, 2020.

(51) Int. Cl. A01D 57/26; A01D 43/10

(52) U.S. Cl. CPC A01D 57/26; A01D 43/102

(57) ABSTRACT

An agricultural machine includes a cutting assembly, a forming assembly including a swathboard and/or a forming shield, at least one actuator, and a controller. The actuator is configured to change a position of the forming assembly. The controller is in communication with the actuator, and is configured to change the position of the forming assembly responsive to an expected or measured crop density. A method of operating an agricultural machine includes propelling an agricultural machine through a field and changing a position of the forming assembly based at least in part on an expected or measured crop density. The forming assembly may be adjusted to maintain an approximately constant windrow height or to produce windrows that are expected to be ready for baling or raking at the same time (e.g., after a period of drying).

### CROSS-REFERENCE TO RELATED APPLICATION

This application claims the benefit of the filing date of U.S. Provisional Patent Application 63/015,183, “Agricultural Machines and Methods for Controlling Windrow Properties,” filed Apr. 24, 2020, the entire disclosure of which is incorporated herein by reference.

### FIELD

Embodiments of the present disclosure relate generally to machines and methods of preparing crops for use as feed. In particular, embodiments relate to windrowers, mowers, etc., and to methods of forming windrows.

### BACKGROUND

Windrowers and other self-propelled harvesters have long been used to harvest crops for hay and forage. A conventional windrower includes a laterally extending header supported by a windrower chassis. As the windrower is advanced through a field, the header severs a swath of standing forage plants, such as grasses, alfalfa, wheat, etc. The header also collects the severed forage material and discharges the material rearwardly onto the ground in the form of a windrow extending behind the windrower. Windrowers can employ different types of headers, including sickle headers and rotating disc headers.

The windrow is typically allowed to dry for a period of time, after which the crop is collected and baled. Various factors affect how quickly cut crop material dries, such as crop moisture, ground moisture, windrow dimensions and density, and crop crimping. To produce high quality bales, the crop should be baled when moisture levels are within certain ranges (which vary by the type of crop). Moisture levels too high can lead to mold or other damage during storage, whereas moisture levels too low can cause excess nutrient loss before baling and difficulty forming coherent bales. Uneven moisture levels make it difficult to select a time for baling at which the crop is neither too wet nor too dry. Thus, bales typically have one or more portions that are outside a preferred moisture level range.

### BRIEF SUMMARY

In some embodiments, an agricultural machine includes a cutting assembly, a forming assembly including a swathboard and/or a forming shield, at least one actuator, and a controller. The at least one actuator is configured to change a position of the forming assembly. The controller is in communication with the at least one actuator, and is configured to change the position of the forming assembly responsive to an expected or measured crop density. The forming assembly may be adjusted to maintain an approximately constant windrow height or to produce windrows that are expected to be ready for baling or raking at the same time (e.g., after a period of drying).

A method of operating an agricultural machine includes propelling the machine through a field and changing a position of the forming assembly based at least in part on an expected or measured crop density.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified side view of an example self-propelled windrower;

FIG. 2 is a simplified side view of conditioner rolls and a swathboard of the windrower of FIG. 1;

FIG. 3 is a simplified side view of cut crop material passing through conditioner rolls and pushed downward by a swathboard;

FIG. 4 is a simplified side view of cut crop material passing through conditioner rolls and pushed inward by forming shields;

FIG. 5 is a simplified top view of cut crop material passing through conditioner rolls and pushed inward by forming shields;

FIG. 6 is a simplified top view of cut crop material passing through conditioner rolls and pushed inward by forming shields orientated to form a narrower windrow than in FIG. 5;

FIG. 7 is a simplified flow chart illustrating a method of operating an agricultural machine; and

FIG. 8 illustrates an example computer-readable storage medium comprising processor-executable instructions configured to embody one or more of the methods of operating an agricultural machine, such as the method illustrated in FIG. 7.

### DETAILED DESCRIPTION

All references cited herein are incorporated herein in their entireties. If there is a conflict between definitions herein and in an incorporated reference, the definition herein shall control.

The illustrations presented herein are not actual views of any tillage implement or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

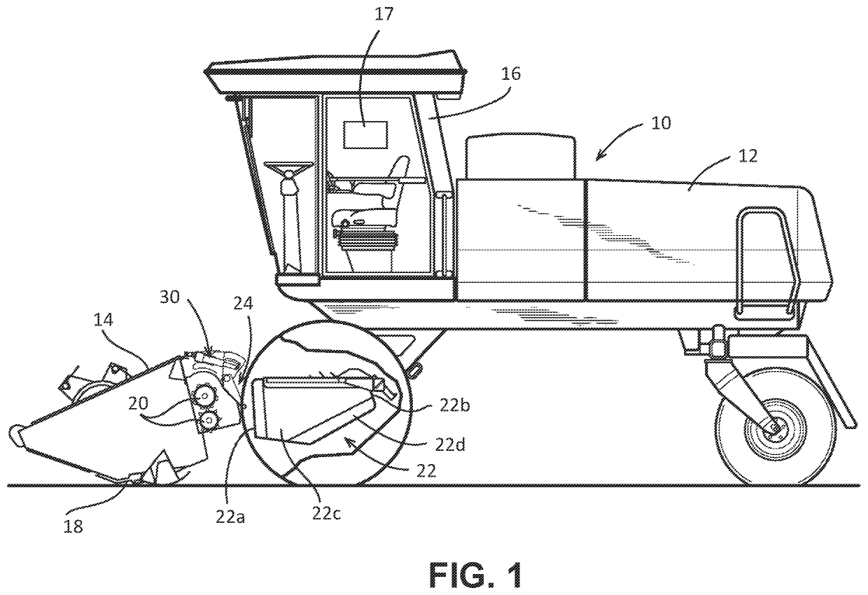

FIG. 1 is a simplified side view of an example agricultural machine depicted as self-propelled windrower 10. In some embodiments, pull-type or other types of harvesting machines may be used, such as mowers, including a mounted mower frame, a triple mower, or a pull-type mower. The windrower 10 broadly includes a self-propelled tractor 12 and a header 14 attached to and carried by the front of the tractor 12. In some embodiments, the header 14 may be a mower or a hay header. The operator drives the windrower 10 from a cab 16, which includes an operator station having a tractor seat and one or more user interfaces (e.g., FNR joystick, display monitor, switches, buttons, etc.) that enable the operator to control various functions of the tractor 12 and header 14. In one embodiment, a controller 17 or computing system is disposed in the cab 16, though in some embodiments, the controller 17 may be located elsewhere or include a distributed architecture having plural computing devices, coupled to one another in a network, throughout various locations within the tractor 12 (or in some embodiments, located in part externally and in remote communication with one or more local computing devices).

The header 14 includes a cutter 18, a conditioning system, and a forming assembly, which may include forming shields 22 and/or a swathboard 24. The cutter 18 is configured for severing standing crops as the windrower 10 moves through the field. The conditioning system, in the depicted embodiment, includes one or more pairs of conditioner rolls 20. The forming assembly may include a pair of rearwardly converging windrow forming shields 22 located behind the conditioner rolls 20. The swathboard 24 is located between the conditioner rolls 20 and the forming shields 22. In some embodiments, the conditioning system may be of a different design, such as a flail-type conditioning system. In self-propelled harvesters, the forming shields 22 are typically supported partly by the header 14 and partly by the tractor 12, while in pull-type harvesters the forming shields are typically carried by the header only. In some embodiments, the forming assembly may be carried by the tractor 12. In other embodiments, the forming assembly may be differently configured (e.g., using a single shield or additional shields of the same or different geometric configuration) to form harvested crop into a windrow having a selected width or shape.

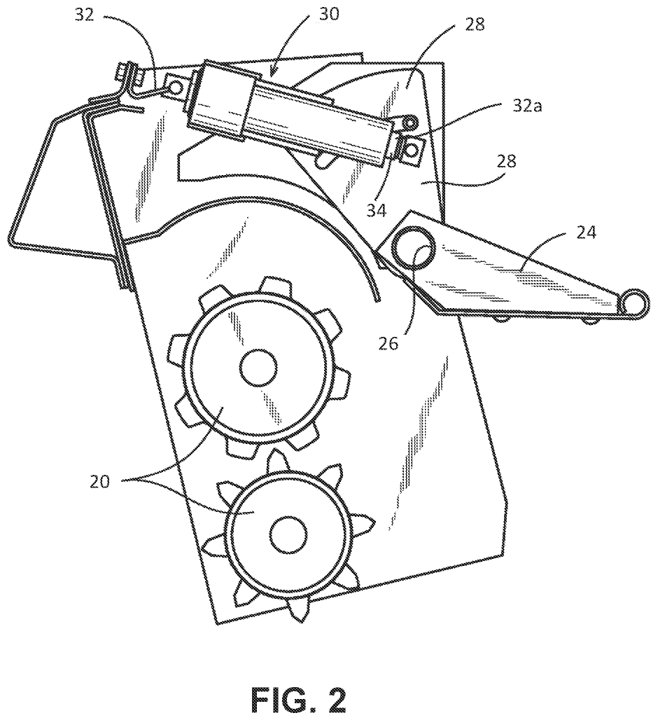

The conditioner rolls 20, depicted in FIG. 1 as a single pair (though an additional pair may be used in some embodiments), have the characteristic of projecting a stream of conditioned materials rearwardly therefrom and toward the swathboard 24 and the forming shields 22 as the crop materials issue from the conditioner rolls 20. In FIG. 1, the swathboard 24 is in a lowered position. FIG. 2 is a more detailed simplified side view of the conditioner rolls 20 and the swathboard 24, and the swathboard 24 is shown fully raised.

The swathboard 24 is fixed to a transversely extending tube 26. A crank 28 is fixed to the tube 26 and projects therefrom for rotating the crank 28, and thus the swathboard 24 can move between the fully raised position of FIG. 2 and the fully lowered position of FIG. 1. The swathboard 24 serves as an initial impact point for the crop material discharged from the conditioner rolls 20. The angle of the swathboard 24 determines if or where along the length of the forming assembly the crop material impacts the forming shields 22. In one embodiment, an actuator 30 is operably connected between the crank 28 and a mounting lug 32 on the frame of the header 14. The actuator 30 may include an electromechanical actuator, a pneumatic actuator, a magnetic actuator, a hydraulic actuator, etc., and may operate, for example, with linear or rotary mechanisms. In some embodiments, the actuator 30 may contain a reversible electric motor that drives a worm gear to extend and retract a moving component (e.g., the rod 32a) of the actuator 30. Additional information about structures of the swathboard 24 and forming shields 22 may be found in U.S. Pat. No. 5,930,988, “On-the-go from the Tractor Seat Windrow Adjustment,” issued Aug. 3, 1999; and U.S. Patent Application Publication 2019/0021229, “Automatic Control of Windrower Swathboard,” published Jan. 24, 2019.

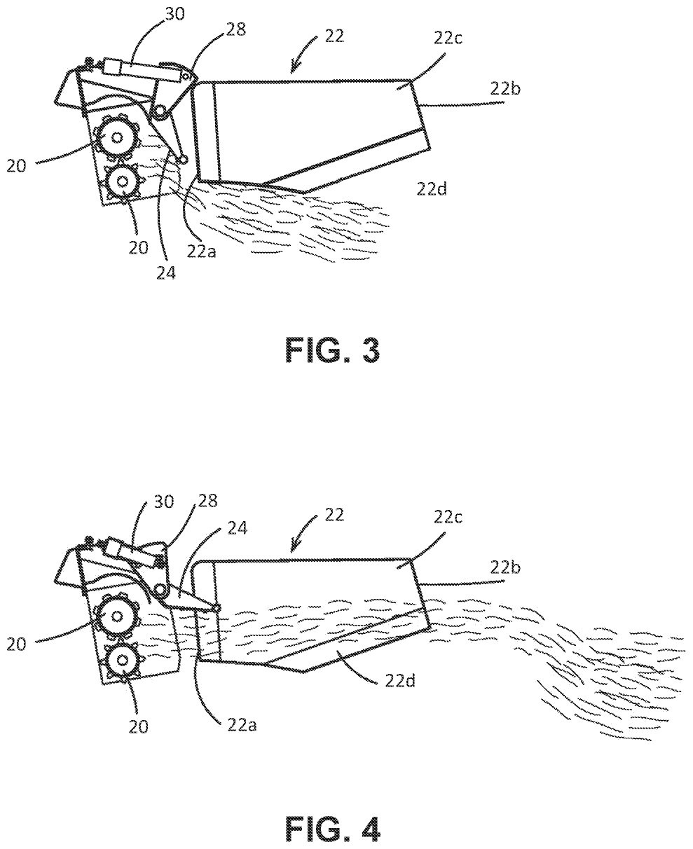

FIGS. 3 and 4 illustrate how the position of the swathboard 24 can affect windrow formation. As shown in FIG. 3, when the swathboard 24 is lowered, the stream of crop material issuing from the conditioner rolls 20 is directed by the swathboard 24 down to the ground, and may never engage the forming shields 22. In this configuration, a wide swath is formed.

When the swathboard 24 is raised, as depicted in FIG. 4, the stream largely bypasses the swathboard 24 and is acted upon by the forming shields 22 to form a windrow in accordance with the positions of the forming shields 22. In this configuration, a narrower swath is formed, having been narrowed by the forming shields 22. Adjustments of the swathboard 24, such as according to the control described in U.S. Pat. No. 5,930,988 (referenced above), may enable a variation of the windrow width and/or shape at or between these two extremes.

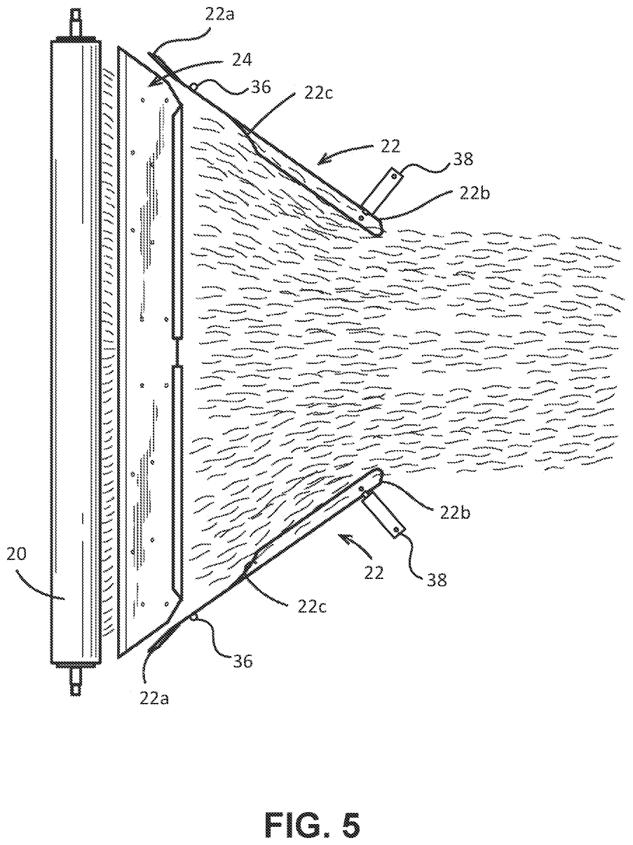

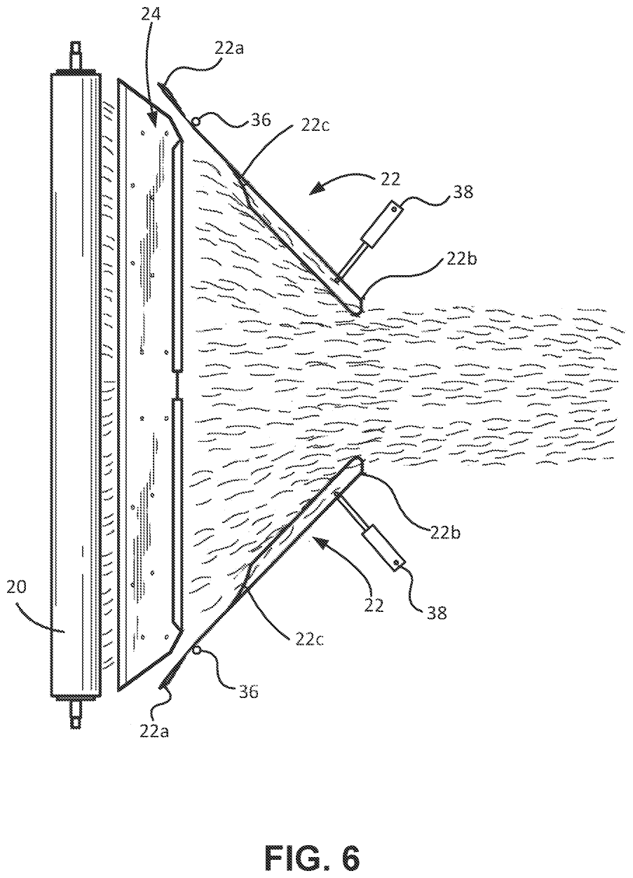

FIGS. 5 and 6 are simplified top views of the conditioner rolls 20, swathboard 24, and forming shields 22. The forming shields 22 may each be fixed to a pivot 36 attached to the windrower 10 or otherwise mounted to enable the forming shields 22 to rotate. Actuators 38 may also connect the forming shields 22 to the windrower 10. The actuators 38 may enable movement of the forming shields 22 outward (FIG. 5), and inward (FIG. 6). Note that the connection of the actuators 38 to the windrower 10 is omitted from FIGS. 5 and 6 for clarity. The actuators 38 may include electromechanical actuators, pneumatic actuators, magnetic actuators, hydraulic actuators, etc., and may operate, for example, with linear or rotary mechanisms. In some embodiments, the actuators 38 may contain reversible electric motors that drive worm gears to extend and retract moving components (e.g., rods) of the actuators 38.

With continued reference to FIGS. 1, 5, and 6, each of the forming shields 22 has a front end 22a, a rear end 22b, and an elongated deflecting surface 22c extending between the front and rear ends 22a and 22b. The front ends 22a of the forming shields 22 are spaced apart by a distance that substantially corresponds to the width of the conditioner rolls 20 in a direction extending transversely to the path of travel of the windrower 10, while the rear ends 22b of the forming shields 22 are spaced apart by a distance that is substantially less than the width of the conditioner rolls 20. Consequently, the forming shields 22 converge rearwardly (e.g., tapered), somewhat in the nature of a funnel, to correspondingly taper down the stream of crop materials issuing from the conditioner rolls 20 and impinging upon the forming shields 22. In one embodiment, the front ends 22a of the forming shields 22 flare slightly outward, while the lower rear margins 22d of the forming shields 22 are curled slightly inward, though other configurations may be used.

FIGS. 5 and 6 illustrate how the position of the forming shields 22 can affect windrow formation. As shown in FIG. 5, when the forming shields 22 are rotated to have a relatively wider outlet (i.e., referring to the distance between the rear ends 22d of the forming shields 22), the stream of crop material issuing from the conditioner rolls 20 engages the forming shields 22 to form a relatively wide swath. As shown in FIG. 6, when the forming shields 22 are rotated to have a relatively narrower outlet, the stream of crop material issuing from the conditioner rolls 20 forms a relatively narrow swath.

The controller 17 may be configured to adjust the actuators 30, 38, to change the position of the swathboard 24 and/or the forming shields 22 in response to an expected or measured crop density. For example, during a field operation, the forming shields 22 may be set to form a narrow windrow in an area of the field in which crop is less dense (e.g., lower population, lower average crop height, etc.), and may be set to form a wide windrow in an area of the field in which crop is more dense. Thus, windrows formed may have approximately uniform height throughout the field, which may facilitate more uniform drying. This may improve the quality of baled hay because baling properties are affected by moisture levels. If the windrows are of approximately uniform height, and dry at approximately the same rate, they may be ready for baling at approximately the same time. This compares favorably to windrows formed by conventional methods, which often experience significant variations in moisture levels within a single field. This can lead to challenges during the baling process: high density areas will retain dew moisture longer, and by the time they have reached a suitable baling moisture, lower density areas will have dried past a suitable baling moisture. This results in both dry matter and quality loss. By controlling the windrow height, the overall quality (and therefore value) of the hay baled can be increased.

The controller 17 may determine the expected or measured crop density using information from various sources. For example, the controller 17 may consider one or more operating parameters of the tractor 12 or header 14, such as power consumed by the header 14, roll pressure of the conditioner rolls 20, etc. The controller 17 may also consider historical data (e.g., a field map including measurements of prior harvests, planting data, irrigation data, soil quality data, etc.) or contemporaneous or near-contemporaneous data related to the crop material (e.g., satellite photography, drone photography, header-mounted cameras, infrared sensors, ultrasonic sensors, moisture sensors, crop-height sensors, capacitive sensors, load cells, and piezoelectric sensors, etc.). For example, the controller 17 may receive data from sensors such as those described in more detail in U.S. Provisional Patent Application 63/015,219, “Methods of Measuring Harvested Crop Material,” filed Apr. 24, 2020; and U.S. Provisional Patent Application 63/015,204, “Agricultural Machines Comprising Capacitive Sensors, and Related Methods and Apparatus,” filed Apr. 24, 2020. In some embodiments, the header 14 or tractor 12 may include a sensor configured to measure the mass of crop material cut, which may be used to set the position of the swathboard 24 and/or the forming shields 22. The controller 17 may correlate the expected or measured crop density with a height of a windrow formed at certain positions of the swathboard 24 and/or the forming shields 22. Thus, the controller 17 can determine how to adjust the swathboard 24 and/or the forming shields 22 to make the windrow have a selected height. In some embodiments, the controller 17 may be configured to control the positions of the swathboard 24 and/or the forming shields 22 to form windrows that are expected to be ready for baling or raking at the same time in the future (e.g., the windrows may be expected to dry to approximately the same moisture level at a preselected future time). Appropriate swathboard 24 and forming shield 22 positions may be determined based on moisture, crop density, crop height, or any other property or combination of properties, and may also incorporate drying models, weather predictions, etc.

In some embodiments, the controller 17 may operate autonomously or semi-autonomously. For example, the operator may set initial operating parameters, and may control steering and propulsion of the tractor 12. The controller 17 may adjust the position of the swathboard 24 and/or the forming shields 22 as crop conditions (measured or expected) change. For example, if the controller 17 has access to a map of expected conditions, the controller 17 may use data from a Global Navigation Satellite System (GNSS) to determine the location of the tractor 12 within the field and adjust the swathboard 24 and/or the forming shields 22 to maintain an approximately uniform windrow depth. The controller 17 may operate in a similar manner with any other available data. Thus, the controller 17 may change the position of the swathboard 24 and/or the forming shields 22 without input from the operator. In certain embodiments, the controller 17 may change a ground speed of the tractor 12 or header speed based on the expected or measured crop density, such as to have constant throughput in the header 14.

The controller 17 may adjust the position of the swathboard 24 and/or the forming shields 22 based on relative values. That is, the precise properties of the crop or the windrow need not be known at the time of cutting, yet the windrows in a single field can be sized to dry at approximately the same rate. In such embodiments, an operator can test a representative sample of windrows to determine moisture levels, and once the moisture levels are within a selected range, the field can be harvested (including windrows of different width, shape, etc.).

If the windrower 10 encounters field conditions that are outside the capability of the swathboard 24 and the forming shields 22 to maintain a uniform windrow, the controller 17 may alert the operator by identifying this portion of the field graphically on a user interface, so that the operator may make other adjustments to manage this portion of the field.

The controller 17 may also include a user interface configured to display at least one informational element. For example, the controller 17 may display a measured operating parameter, the position of the swathboard 24, the position of the forming shields 22, or a density, height, width, or shape of a windrow formed.

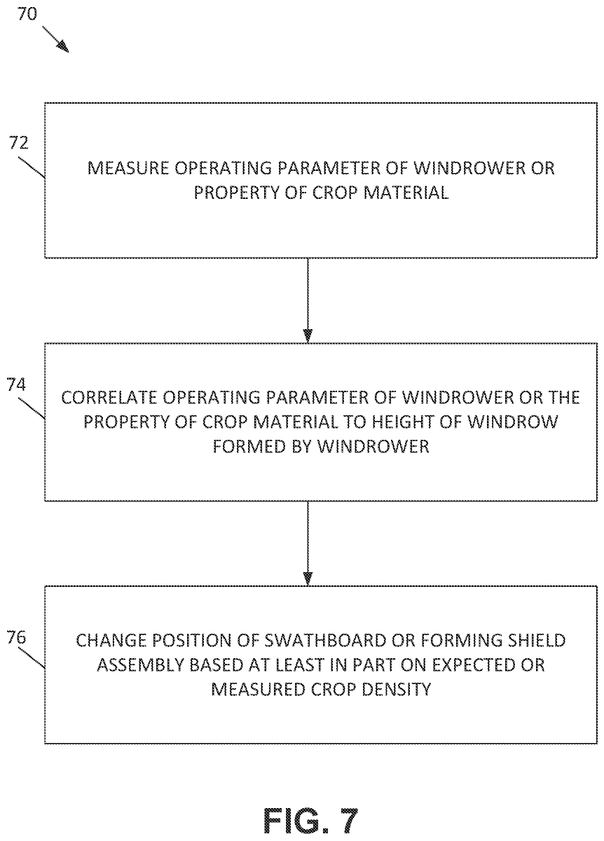

FIG. 7 is a simplified flow chart illustrating a method 70 of using the windrower 10 to harvest a crop and form a windrow in an agricultural field. In block 72, an operating parameter of the windrower 10 or a property of the crop material in the field is measured, such as by measuring the mass of crop material cut. In block 74, the operating parameter or property of crop material is correlated to a height, density, or shape of a windrow that is formed by the cut crop material at the current positions of the swathboard 24 and the forming shields 22. In block 76, the position of the swathboard 24 and/or the forming shields 22 is changed based at least on expected or measured crop density.

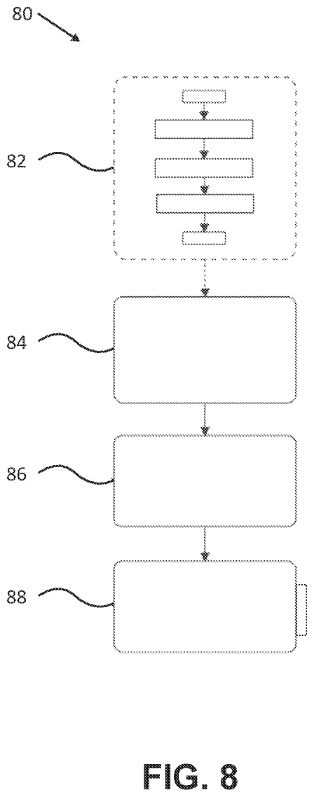

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 8, wherein an implementation 80 includes a computer-readable storage medium 82 (e.g., a flash drive, CD-R, DVD-R, application-specific integrated circuit (ASIC), field-programmable gate array (FPGA), a platter of a hard disk drive, etc.), on which is computer-readable data 84. This computer-readable data 84 in turn includes a set of processor-executable instructions 86 configured to operate according to one or more of the principles set forth herein. In some embodiments, the processor-executable instructions 86 may be configured to cause a computer associated with the windrower 10 (FIG. 1) to perform operations 88 when executed via a processing unit, such as at least some of the example method 70 depicted in FIG. 7. In other embodiments, the processor-executable instructions 86 may be configured to implement a system, such as at least some of the example windrower 10 depicted in FIG. 1. Many such computer-readable media may be devised by those of ordinary skill in the art that are configured to operate in accordance with one or more of the techniques presented herein.

Additional non limiting example embodiments of the disclosure are described below.

Embodiment 1: An agricultural machine comprising a cutting assembly, a forming assembly comprising at least one of a swathboard or a forming shield, at least one actuator configured to change a position of the forming assembly, and a controller in communication with the at least one actuator. The controller is configured to change the position of the forming assembly responsive to an expected or measured crop density.

Embodiment 2: The agricultural machine of Embodiment 1, wherein the controller is configured to change the position of the swathboard or the forming shield assembly to maintain approximately constant windrow height.

Embodiment 3: The agricultural machine of Embodiment 1, wherein the controller is configured to change the position of the swathboard or the forming shield assembly to produce at least one windrow in a field, such that the at least one windrow is expected to be ready for baling or raking at a single future time.

Embodiment 4: The agricultural machine of any of Embodiment 1 through Embodiment 3, further comprising at least one sensor configured to measure an operating parameter of the agricultural machine or a property of crop material.

Embodiment 5: The agricultural machine of Embodiment 4, wherein the at least one sensor is configured to measure at least one operating parameter selected from the group consisting of header power usage and roll pressure.

Embodiment 6: The agricultural machine of Embodiment 4, wherein the at least one sensor comprises a sensor selected from the group consisting of cameras, infrared sensors, ultrasonic sensors, moisture sensors, crop-height sensors, capacitive sensors, load cells, and piezoelectric sensors.

Embodiment 7: The agricultural machine of any of Embodiment 4 through Embodiment 6, wherein the controller is configured to change the position of the forming assembly based at least in part on the measured operating parameter or property of crop material.

Embodiment 8: The agricultural machine of any of Embodiment 1 through Embodiment 7, wherein the controller is configured to change the position of the forming assembly without input from an operator of the agricultural machine.

Embodiment 9: The agricultural machine of any of Embodiment 1 through Embodiment 8, further comprising a user interface configured to display at least one informational element selected from the group consisting of a measured operating parameter, the position of the forming assembly, a density of a windrow formed by the agricultural machine, a height of a windrow formed by the agricultural machine, a width of a windrow formed by the agricultural machine, and a shape of a windrow formed by the agricultural machine.

Embodiment 10: The agricultural machine of any of Embodiment 1 through Embodiment 9, wherein the controller is configured to change a ground speed of the agricultural machine responsive to the expected or measured crop density.

Embodiment 11: The agricultural machine of any of Embodiment 1 through Embodiment 10, wherein the agricultural machine comprises a machine selected from the group consisting of a windrower, a triple mower, a pull-type mower, and a mounted mower frame.

Embodiment 12: A method of operating an agricultural machine, the method comprising propelling an agricultural machine through a field. The agricultural machine comprises a chassis with wheels coupled thereto, an engine, a ground drive system coupled to the wheels and the engine, a cutting assembly, a forming assembly comprising at least one of a swathboard or a forming shield, at least one actuator configured to change a position of the forming assembly, and a controller in communication with the at least one actuator. The method further comprises changing a position of the forming assembly based at least in part on an expected or measured crop density.

Embodiment 13: The method of Embodiment 12, wherein changing a position of the swathboard or the forming shield assembly comprises maintaining an approximately constant windrow height.

Embodiment 14: The method of Embodiment 12, wherein changing a position of the swathboard or the forming shield assembly comprises producing at least one windrow in a field, wherein the at least one windrow is expected to be ready for baling or raking at a single future time.

Embodiment 15: The method of any of Embodiment 12 through Embodiment 14, wherein changing the position of the forming assembly comprises changing the position of the forming assembly without operator input.

Embodiment 16: The method of any of Embodiment 12 through Embodiment 15, further comprising measuring an operating parameter of the agricultural machine or a property of crop material.

Embodiment 17: The method of Embodiment 16, further comprising correlating the operating parameter of the agricultural machine or the property of crop material to a height of a windrow formed by the agricultural machine.

Embodiment 18: The method of Embodiment 16 or Embodiment 17, wherein measuring an operating parameter of the agricultural machine or a property of crop material comprises measuring a mass of crop material cut by the agricultural machine.

Embodiment 19: The method of any of Embodiment 12 through Embodiment 18, wherein changing a position of the forming assembly based at least in part on an expected or measured crop density comprises changing a position of the forming assembly based at least in part on a field map.

Embodiment 20: A non-transitory computer-readable storage medium, the computer-readable storage medium including instructions that when executed by a computer, cause the computer to perform the method of any one of Embodiment 12 through Embodiment 19.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various crop-harvesting machine types and configurations.

What is claimed is:

1. An agricultural machine, comprising:
a cutting assembly;
a forming assembly comprising at least one of a swathboard or a forming shield;
at least one actuator configured to change a position of the forming assembly; and
a controller in communication with the at least one actuator, wherein the controller is configured to change the position of the forming assembly responsive to an expected or measured crop density to maintain approximately constant windrow height.

2. The agricultural machine of claim 1, further comprising at least one sensor configured to measure an operating parameter of the agricultural machine or a property of crop material.

3. The agricultural machine of claim 2, wherein the at least one sensor is configured to measure at least one operating parameter selected from the group consisting of header power usage and roll pressure.

4. The agricultural machine of claim 2, wherein the at least one sensor comprises a sensor selected from the group consisting of cameras, infrared sensors, ultrasonic sensors, moisture sensors, crop-height sensors, capacitive sensors, load cells, and piezoelectric sensors.

5. The agricultural machine of claim 2, wherein the controller is configured to change the position of the forming assembly based at least in part on the measured operating parameter or property of crop material.

6. The agricultural machine of claim 1, wherein the controller is configured to change the position of the forming assembly without input from an operator of the agricultural machine.

7. The agricultural machine of claim 1, further comprising a user interface configured to display at least one informational element selected from the group consisting of a measured operating parameter, the position of the forming assembly, a density of a windrow formed by the agricultural machine, a height of a windrow formed by the agricultural machine, a width of a windrow formed by the agricultural machine, and a shape of a windrow formed by the agricultural machine.

8. The agricultural machine of claim 1, wherein the controller is configured to change a ground speed of the agricultural machine responsive to the expected or measured crop density.

9. The agricultural machine of claim 1, wherein the agricultural machine comprises a machine selected from the group consisting of a windrower, a triple mower, a pull-type mower, and a mounted mower frame.

10. A method of operating an agricultural machine, the method comprising:
propelling an agricultural machine through a field, the agricultural machine comprising;
a chassis with wheels coupled thereto;
an engine;
a ground drive system coupled to the wheels and the engine;
a cutting assembly;
a forming assembly comprising at least one of a swathboard or a forming shield;
at least one actuator configured to change a position of the forming assembly; and
a controller in communication with the at least one actuator; and
changing a position of the forming assembly based at least in part on an expected or measured crop density to maintain an approximately constant windrow height.

11. The method of claim 10, wherein maintaining an approximately constant windrow height comprises changing the position of the forming assembly without operator input.

12. The method of claim 10, further comprising measuring an operating parameter of the agricultural machine or a property of crop material.

13. The method of claim 12, further comprising correlating the operating parameter of the agricultural machine or the property of crop material to the windrow height.

14. The method of claim 12, wherein measuring an operating parameter of the agricultural machine or a property of crop material comprises measuring a mass of crop material cut by the agricultural machine.

15. The method of claim 10, wherein changing a position of the forming assembly based at least in part on an expected or measured crop density comprises changing a position of the forming assembly based at least in part on a field map.

16. A non-transitory computer-readable storage medium, the computer-readable storage medium including instructions that when executed by a computer, cause the computer to perform the method of claim 10.

17. An agricultural machine, comprising:
a cutting assembly;
a forming assembly comprising at least one of a swathboard or a forming shield;
at least one actuator configured to change a position of the forming assembly; and
a controller in communication with the at least one actuator, wherein the controller is configured to change the position of the forming assembly responsive to an expected or measured crop density to produce at least one windrow in a field, such that the at least one windrow is expected to be ready for baling or raking at a single future time.

18. The agricultural machine of claim 17, further comprising at least one sensor configured to measure an operating parameter of the agricultural machine or a property of crop material.

19. The agricultural machine of claim 18, wherein the at least one sensor is configured to measure at least one operating parameter selected from the group consisting of header power usage and roll pressure.

20. The agricultural machine of claim 18, wherein the at least one sensor comprises a sensor selected from the group consisting of cameras, infrared sensors, ultrasonic sensors, moisture sensors, crop-height sensors, capacitive sensors, load cells, and piezoelectric sensors.

21. The agricultural machine of claim 18, wherein the controller is configured to change the position of the forming assembly based at least in part on the measured operating parameter or property of crop material.

22. The agricultural machine of claim 17, wherein the controller is configured to change the position of the forming assembly without input from an operator of the agricultural machine.

23. The agricultural machine of claim 17, further comprising a user interface configured to display at least one informational element selected from the group consisting of a measured operating parameter, the position of the forming assembly, a density of a windrow formed by the agricultural machine, a height of a windrow formed by the agricultural machine, a width of a windrow formed by the agricultural machine, and a shape of a windrow formed by the agricultural machine.

24. The agricultural machine of claim 17, wherein the controller is configured to change a ground speed of the agricultural machine responsive to the expected or measured crop density.

25. The agricultural machine of claim 17, wherein the agricultural machine comprises a machine selected from the group consisting of a windrower, a triple mower, a pull-type mower, and a mounted mower frame.

26. A method of operating an agricultural machine, the method comprising:
propelling an agricultural machine through a field, the agricultural machine comprising;
a chassis with wheels coupled thereto;
an engine;
a ground drive system coupled to the wheels and the engine;
a cutting assembly;
a forming assembly comprising at least one of a swathboard or a forming shield;
at least one actuator configured to change a position of the forming assembly; and
a controller in communication with the at least one actuator; and
changing a position of the forming assembly based at least in part on an expected or measured crop density to produce at least one windrow in a field, wherein the at least one windrow is expected to be ready for baling or raking at a single future time.

27. The method of claim 26, wherein changing the position of the forming assembly comprises changing the position of the forming assembly without operator input.

28. The method of claim 26, further comprising measuring an operating parameter of the agricultural machine or a property of crop material.

29. The method of claim 28, further comprising correlating the operating parameter of the agricultural machine or the property of crop material to a windrow height.

30. The method of claim 28, wherein measuring an operating parameter of the agricultural machine or a property of crop material comprises measuring a mass of crop material cut by the agricultural machine.

31. The method of claim 26, wherein changing a position of the forming assembly based at least in part on an expected or measured crop density comprises changing a position of the forming assembly based at least in part on a field map.

32. A non-transitory computer-readable storage medium, the computer-readable storage medium including instructions that when executed by a computer, cause the computer to perform the method of claim 26.
